(19) United States
(12) Patent Application Publication
(10) Pub. No.: US 2014/0368477 A1
(43) Pub. Date: Dec. 18, 2014

(54) SOURCE DRIVER

(71) Applicant: Novatek Microelectronics Corp., Hsinchu (TW)

(72) Inventor: Szu-Ying Huang, Taoyuan County (TW)

(73) Assignee: Novatek Microelectronics Corp., Hsinchu (TW)

(21) Appl. No.: 14/048,033

(22) Filed: Oct. 7, 2013

(30) Foreign Application Priority Data
Jun. 17, 2013 (TW) 102121415

(51) Int. Cl. G09G 3/36

(52) U.S. Cl. CPC G09G 3/3685
USPC 345/204; 345/87

(57) ABSTRACT

A source driver for driving a display panel is provided. The source driver includes a data processing circuit, a data transmission interface and a driving channel. The data processing circuit receives a frame data and converts the frame data having a serial format into the frame data having a parallel format. The data processing circuit copies the frame data. The frame data corresponds to a display frame. The data transmission interface is coupled to the data processing circuit and transmits the copied frame data. The driving channel is coupled to the data transmission interface and receives the copied frame data and drives the display panel by the copied frame data. For an identical display frame, a data quantity of the frame data transmitted by the data transmission interface is greater than a data quantity of the frame data received by the data processing circuit.

### CROSS-REFERENCE TO RELATED APPLICATION

This application claims the priority benefit of Taiwan application serial no. 102121415, filed on Jun. 17, 2013. The entirety of the above-mentioned patent application is hereby incorporated by reference herein and made a part of this specification.

### BACKGROUND OF THE DISCLOSURE

1. Field of the Disclosure

The disclosure relates to a source device, and particularly to a source driver for driving a display panel.

2. Description of Related Art

A liquid crystal display (LCD) monitor has characteristics of light weight, low power consumption, zero radiation, etc. and is widely used in many information technology (IT) products, such as computer systems, mobile phones, and personal digital assistants (PDAs). The operating principle of the LCD monitor is based on the fact that different twist states of liquid crystals result in different polarization and refraction effects on light passing through the liquid crystals. Thus, the liquid crystals can be used to control amount of light emitted from the LCD monitor by arranging the liquid crystals in different twist states, so as to produce light outputs at various brightness, and diverse gray levels of red, green and blue light.

In order to perform above operation of displaying images, the LCD is usually driven by a timing controller, a gate driver and a source driver. Generally, when the LCD is operated in a high frame rate, the source driver is also required to be operated in a higher speed, accordingly. However, during a high speed operation, the source driver may consume more power, and is prone to problems such as overheating and electromagnetic interference (EMI).

### SUMMARY OF THE DISCLOSURE

The disclosure is directed to a source driver capable of reducing power consumption to lower temperature and solving problem of electromagnetic interference.

The disclosure provides a source driver for driving a display panel. The source driver includes a data processing circuit, a data transmission interface and a driving channel. The data processing circuit is configured to receive a frame data and convert the frame data from a serial format into a parallel format. The data processing circuit copies the frame data. The frame data corresponds to a display frame. The data transmission interface is coupled to the data processing circuit and configured to transmit the copied frame data. The driving channel is coupled to the data transmission interface and configured to receive the copied frame data and drive the display panel by the copied frame data. For an identical display frame, a data quantity of the frame data transmitted by the data transmission interface is greater than a data quantity of the frame data received by the data processing circuit.

In an embodiment of the disclosure, the data processing circuit includes a data converting circuit and a data copying circuit. The data converting circuit is configured to receive a frame data and convert the frame data from the serial format into the parallel format. The data copying circuit is coupled to the data converting circuit and configured to receive the frame data having the parallel format and copy the frame data having the parallel format.

In an embodiment of the disclosure, the data processing circuit includes a data copying circuit and a data converting circuit. The data copying circuit is configured to receive the frame data and copy the frame data. The data converting circuit is coupled to the data copying circuit and configured to receive the copied frame data and covert the copied frame data from the serial format into the parallel format.

The disclosure provides a source driver for driving a display panel. The source driver includes a data converting circuit, a data transmission interface and a plurality of driving channels. The data converting circuit is configured to receive a frame data and convert the frame data from the serial format into the parallel format. The frame data corresponds to a display frame. The data transmission interface is coupled to the data converting circuit and configured to transmit the frame data. The driving channels are coupled to the data transmission interface and configured to receive the frame data and drive the display panel by the copied frame data. For an identical display frame, an identical frame data is stored in two adjacent driving channels among the driving channels.

In an embodiment of the disclosure, each of the driving channels includes a first latch circuit and a second latch circuit. The first latch circuits are configured to receive and store the frame data. The second latch circuit is coupled to the first latch circuit and configured to receive and store the frame data provided by the first latch circuit. For the identical display frame, the identical frame data is received and stored by the first latch circuits of the two adjacent driving channels.

In an embodiment of the disclosure, each of the driving channels includes a first latch circuit and a second latch circuit. The first latch circuits are configured to receive and store the frame data. The second latch circuit is coupled to the first latch circuit and configured to receive and store the frame data provided by the first latch circuit. In the two adjacent driving channels, one of the first latch circuits receives and stores the frame data. For the identical display frame, the one of the first latch circuits provides the frame data to the second latch circuits of the two adjacent driving channels, and the second latch circuits of the two adjacent driving channels respectively receive and store the identical frame data.

Based on above, in the exemplary embodiment of the disclosure, the source driver may selectively decide whether to copy the frame data to reduce its operating speed, so as to reduce power consumption for lowering the temperature and solving the problem of electromagnetic interference.

To make the above features and advantages of the disclosure more comprehensible, several embodiments accompanied with drawings are described in detail as follows.

### BRIEF DESCRIPTION OF THE DRAWINGS

FIG. 1 is a schematic diagram illustrating a source driver according to a related example of the disclosure.

FIG. 2 is a schematic diagram illustrating a source driver according to an embodiment of the disclosure.

FIG. 3, FIG. 4 and FIG. 5 are schematic diagrams respectively illustrating the source drivers according to other embodiments of the disclosure.

### DESCRIPTION OF THE EMBODIMENTS

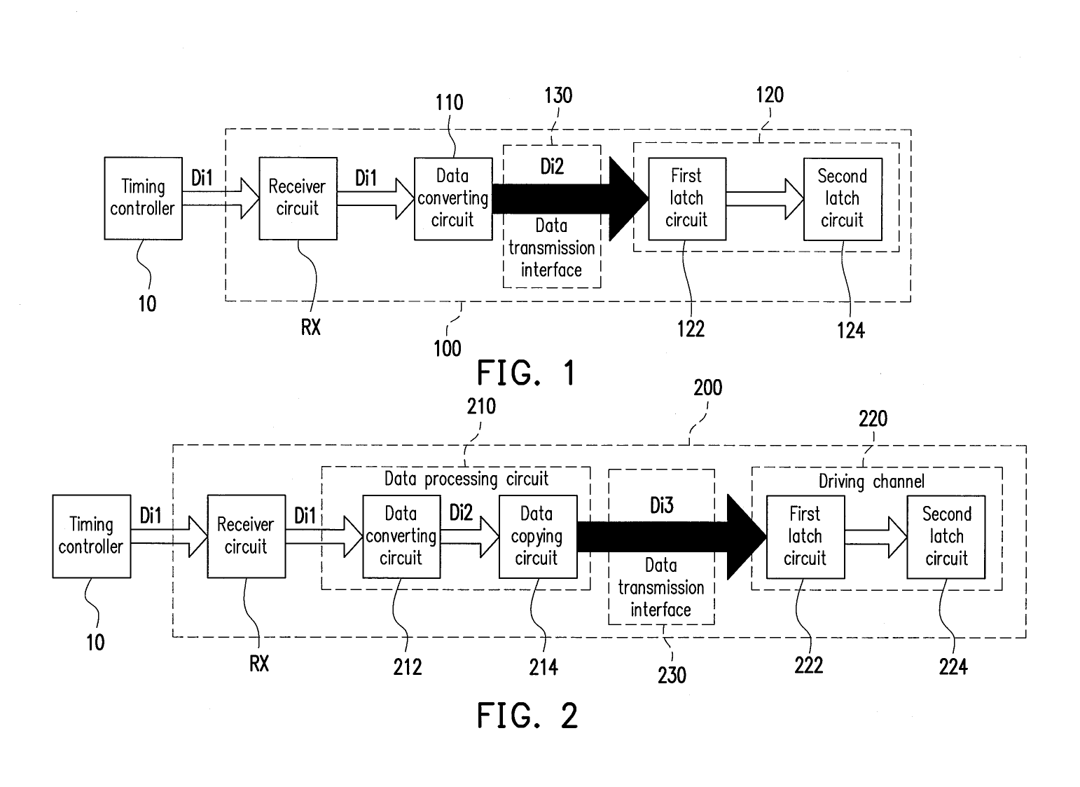

FIG. 1 is a schematic diagram illustrating a source driver according to a related example of the disclosure. Referring to FIG. 1, a source driver 100 of the present related example is configured to receive a frame data Di1 provided by a timing controller 10, so that a display panel (not illustrated) may be driven accordingly to display a corresponding image frame. More specifically, in the present related example, the source driver 100 first receives the frame data Di1 having a serial format by a receiver circuit RX, and then converts the frame data Di1 into a frame data Di2 having a parallel format by a data converting circuit 110. Subsequently, the data converting circuit 110 sequentially transmits the frame data Di2 to be stored in a latch circuit 122 of a driving channel 120 through a data transmission interface 130. When a data quantity stored reaches a specific amount enough for driving a line of pixels, the latch circuit 122 outputs the stored frame data Di2 to be stored in a latch circuit 124. Subsequently, based on a driving time sequence, the latch circuit 124 outputs the stored frame data Di2 to an output buffer amplifier circuit (not illustrated), so as to charge/discharge liquid crystal capacitors of the display panel.

FIG. 2 is a schematic diagram illustrating a source driver according to an embodiment of the disclosure. Referring to FIG. 2, a source driver 200 of the present embodiment includes a receiver circuit RX, a data processing circuit 210, a data transmission interface 230 and a driving channel 220. In the present embodiment, the source driver 200 receives a frame data Di1 provided by a timing controller 10 by the receiver circuit RX, and the frame data Di1 corresponds to a display frame. Subsequently, the data processing circuit 210 receives the frame data Di1 and converts the frame data Di1 from a serial format into a parallel format. Meanwhile, the data processing circuit 210 may also be configured to copy a frame data Di2, so as to generate a copied frame data Di3. Subsequently, the data processing circuit 210 outputs the copied frame data Di3 to the driving channel 220 through the data transmission interface 230. The data transmission interface 230 is coupled between the data processing circuit 210 and the driving channel 220, and configured to transmit the copied frame data Di3. Herein, the data transmission interface 230 includes a data bus. The driving channel 220 is coupled to the data transmission interface 230 and configured to receive the copied frame data Di3 and drive the display panel by the copied frame data Di3.

More specifically, when the display panel is intended to display a rather monotonous frame, it is not required for the display frame to display in high resolution in order to at least solve the problems of electromagnetic interference and rising temperature due to power consumption. In this case, the timing controller 10 may send the frame data Di1 having less data quantity to the source driver 200. Afterwards, data received by the data processing circuit 210 inside of the source driver 200 is then copied to meet a demand of driving the display panel to display a corresponding image frame.

For instance, in an implementation that the source driver 200 is configured with 960 driving channels, when the display frame is not required to be displayed in high resolution, the timing controller 10 may only provide the data quantity enough for driving 480 driving channels, to the source driver 200. Subsequently, the source driver 200 may copy the received data quantity, so the display panel may be driven by the received data quantity being doubled. Therefore, in the present embodiment, only less data quantity is required for the source driver 200 to receive, and the frame data enough for driving the display panel may be provided by said copying operation. Therefore, in the present embodiment, for an identical display frame, a data quantity of the frame data Di3 transmitted by the data transmission interface 230 is greater than a data quantity of the frame data Di1 received by the data processing circuit 210. It should be noted that, amount of the driving channels and sizes of the data quantity are only illustrative in the present embodiment, but the disclosure is not limited thereto.

More specifically, referring back to FIG. 2, the data processing circuit 210 of the present embodiment includes a data converting circuit 212 and a data copying circuit 214. The data converting circuit 212 is configured to receive the frame data Di1 and convert the frame data Di1 from the serial format into the parallel format, so as to be output to the data copying circuit 214. The data copying circuit 214 is coupled between the data converting circuit 212 and the data transmission interface 230, and configured to receive the frame data Di2 having the parallel format and copy the frame data Di2, so as to generate the copied frame data Di3. In brief, after data transmitted by the timing controller 10 is received, the data converting circuit 212 converts serial data into parallel data. When said data is converted into the parallel format, such data is then copied by the data copying circuit 214. Subsequently, the data copying circuit 214 transmits the copied data to the data transmission interface 230 for being sequentially stored to a first latch circuit 222 and a second latch circuit 224 of the driving channel 220.

In the present embodiment, the data processing circuit 210 first performs a format conversion followed by a copying operation to the frame data Di1, but the disclosure is not limited thereto. In another embodiment, the data processing circuit may first perform the copying operation followed by the format conversion to the frame data Di1 instead.

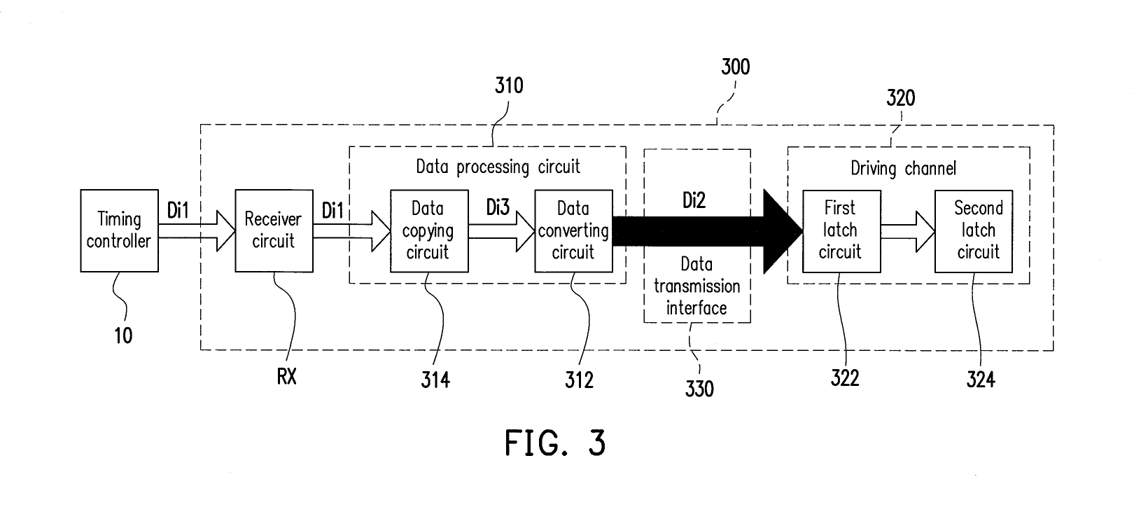

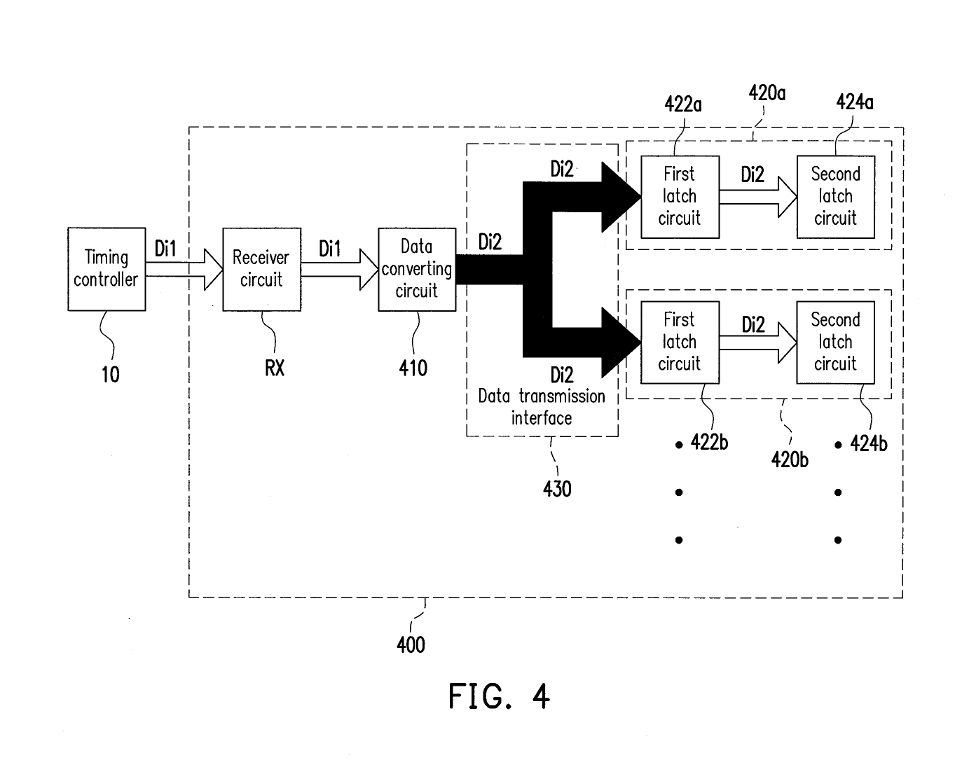

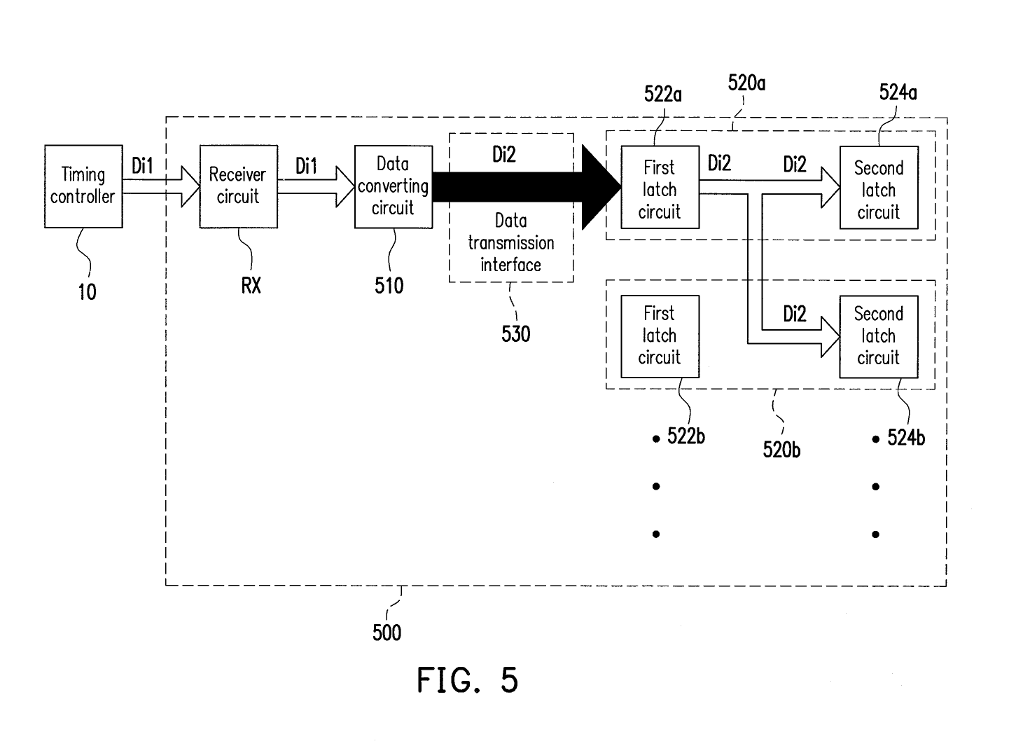

FIG. 3 is a schematic diagram illustrating a source driver according to another embodiment of the disclosure. Referring to FIG. 2 and FIG. 3 together, a source driver 300 of the present embodiment is similar to the source driver 200 depicted in FIG. 2, a major difference between the two is that, for example, a data processing circuit 310 first performs the copying operation to the frame data Di1 and then performs the format conversion to the copied frame data Di3.

More specifically, in the present embodiment, the data copying circuit 314 is configured to receive and copy the frame data Di1 to generate the copied frame data Di3, and the copied frame data Di3 is then output to a data converting circuit 312. The data converting circuit 312 is coupled between the data copying circuit 314 and a data transmission interface 330, and configured to receive the copied frame data Di3, and the copied frame data Di3 is converted from the serial format into the parallel format to generate the frame data Di2 having the parallel format.

In foregoing embodiments, the data processing circuit may first perform the format conversion followed by the copying operation to the frame data, or, first perform the copying operation followed by the format conversion to the frame data, but the disclosure is not limited thereto. In another embodiment, the data processing circuit may also choose not to copy the frame data, and the same effect of copying the frame data may be accomplished by adjusting the data bus or altering storage locations of the data in the driving channels.

FIG. 4 is a schematic diagram illustrating a source driver according to another embodiment of the disclosure. Referring to FIG. 4, a source driver 400 of the present embodiment includes a data converting circuit 410, a data transmission interface 430 and a plurality of driving channels 420a and 420b. The data converting circuit 410 is configured to receive the frame data Di1 and convert the frame data Di1 from a serial format into a parallel format to generate the frame data Di2 having the parallel format. Said frame data corresponds to an image frame displayed on the display panel. The data transmission interface 430 is coupled to the data converting circuit 410 and configured to transmit the frame data Di2. The driving channels 420a and 420b are coupled to the data transmission interface 430 and configured to receive the frame data Di2 and drive the display panel by the copied frame data Di2. In the present embodiment, after the frame data Di1 having the serial format is converted into the frame data Di2 having the parallel format, the data converting circuit 410 may simultaneously transmit the frame data Di2 to the driving channels 420a and 420b through the data transmission interface 430. Therefore, for an identical display frame, an identical frame data Di2 is stored in two adjacent driving channels 420a and 420b among the driving channels of the source driver 400.

More specifically, the driving channels 420a and 420b of the present embodiment respectively includes first latch circuits 422a and 422b and second latch circuits 424a and 424b. The first latch circuits 422a and 422b are configured to receive and store the frame data Di2. Since the data converting circuit 410 simultaneously transmits the identical frame data Di2 to the driving channels 420a and 420b, thus for the identical display frame, the identical frame data Di2 may be received and stored by the first latch circuits 422a and 422b of the two adjacent driving channels 420a and 420b. Subsequently, the second latch circuits 424a and 424b are respectively coupled to the first latch circuits 422a and 422b and configured to receive and store the frame data provided by the first latch circuits 422a and 422b. Since the first latch circuits 422a and 422b are respectively stored with the identical frame data Di2, the second latch circuits 424a and 424b are also stored with the identical frame data Di2, respectively, so as to accomplish the same effect of the copying operation.

FIG. 5 is a schematic diagram illustrating a source driver according to another embodiment of the disclosure. Referring to FIG. 4 and FIG. 5 together, a source driver 500 of the present embodiment is similar to the source driver 400 depicted in FIG. 4, a major difference between the two is that, for example, the frame data is received and stored by one of the first latch circuits of the two adjacent driving channels.

More specifically, in the present embodiment, after the frame data Di1 having the serial format is converted into the frame data Di2 having the parallel format, the data converting circuit 510 may transmit the frame data Di2 to a first latch circuit 522a of a driving channel 520a through the data transmission interface 530. Therefore, in the two adjacent driving channels 520a and 520b, one of the first latch circuits 522a receives and stores the frame data Di2. Subsequently, the first latch circuit 522a simultaneously transmits the frame data Di2 to the second latch circuits 524a and 524b. Therefore, for the identical display frame, one of the first latch circuits 522a respectively provides the identical frame data Di2 to the second latch circuits 524a and 524b of the two adjacent driving channels 520a and 520b. As a result, the second latch circuits 524a and 524b of the two adjacent driving channels 520a and 520b respectively receive and store the identical frame data Di2, such that the same effect of the operation may be accomplished.

In light of above, in the exemplary embodiment of the disclosure, the source driver may reduce its operating speed by copying the frame data, so as to reduce power consumption for lowering the temperature and solving the problem of electromagnetic interference. In addition, the source driver may also choose not to copy the frame data, and the same effect of copying the frame data may be accomplished by adjusting the data bus or altering storage locations of the data in the driving channels.

It will be apparent to those skilled in the art that various modifications and variations can be made to the structure of the disclosed embodiments without departing from the scope or spirit of the disclosure. In view of the foregoing, it is intended that the disclosure cover modifications and variations of this specification provided they fall within the scope of the following claims and their equivalents.

What is claimed is:

1. A source driver for driving a display panel, the source driver comprising:
a data processing circuit configured to receive a frame data, convert the frame data from a serial format into a parallel format, and copy the frame data, wherein the frame data corresponds to a display frame;
a data transmission interface coupled to the data processing circuit and configured to transmit the copied frame data; and
a driving channel coupled to the data transmission interface and configured to receive the copied frame data and drive the display panel by the copied frame data,
wherein for an identical display frame, a data quantity of the frame data transmitted by the data transmission interface is greater than a data quantity of the frame data received by the data processing circuit.

2. The source driver of claim 1, wherein the data processing circuit comprises:
a data converting circuit configured to receive the frame data and convert the frame data from the serial format into the parallel format; and
a data copying circuit coupled to the data converting circuit and configured to receive the frame data having the parallel format and copy the frame data having the parallel format.

3. The source driver of claim 1, wherein the data processing circuit comprises:
a data copying circuit configured to receive the frame data and copy the frame data; and
a data converting circuit coupled to the data copying circuit and configured to receive the copied frame data and covert the copied frame data from the serial format into the parallel format.

4. A source driver for driving a display panel, the source driver comprising:
a data converting circuit configured to receive a frame data, convert the frame data from a serial format into a parallel format, wherein the frame data corresponds to a display frame;
a data transmission interface coupled to the data converting circuit and configured to transmit the frame data; and
a plurality of driving channels coupled to the data transmission interface and configured to receive the frame data and drive the display panel by the frame data,
wherein for an identical display frame, an identical frame data is stored in two adjacent driving channels among the driving channels.

5. The source driver of claim 4, wherein each of the driving channels comprises:
a first latch circuit configured to receive and store the frame data; and
a second latch circuit coupled to the first latch circuit and configured to receive and store the frame data provided by the first latch circuit,
wherein for the identical display frame, the identical frame data is received and stored by the first latch circuits of the two adjacent driving channels.

6. The source driver of claim 4, wherein each of the driving channels comprises:
a first latch circuit configured to receive and store the frame data; and
a second latch circuit coupled to the first latch circuit and configured to receive and store the frame data provided by the first latch circuit,
wherein in the two adjacent driving channels, one of the first latch circuits receives and stores the frame data; for the identical display frame, the one of the first latch circuits provides the frame data to the second latch circuits of the two adjacent driving channels; and the second latch circuits of the two adjacent driving channels respectively receive and store the identical frame data.
